(19) United States
(12) Patent Application Publication
(10) Pub. No.: US 2005/0147035 A1
(43) Pub. Date: Jul. 7, 2005

(54) Multiple services with policy enforcement over a common network

(75) Inventors: Dany Sylvain, Gatineau (CA); Andrew Timms, Ottawa (CA)

Correspondence Address: WITHROW & TERRANOVA, P.L.L.C., P.O. BOX 1287, CARY, NC, 27512, US

(73) Assignee: NORTEL NETWORKS LIMITED, St. Laurent (CA)

(21) Appl. No.: 10/746,433

(22) Filed: Dec. 24, 2003

(51) Int. Cl. H04L 12/26

(52) U.S. Cl. 370/230; 370/401

(57) ABSTRACT

The present invention allows different types of services to be implemented over a common local access network, wherein each service can be ensured the resources necessary to provide the service, and unauthorized use can be prevented. Accordingly, various types of media services may be provided to various types of customer premise equipment, and the packet flows for each of these services may be individually controlled. On either side of the local access network, a customer service edge and a network service edge are provided to establish virtual communication pipes for the respective services. The customer and network service edges will establish the virtual communication pipes and control traffic flow over the virtual communication pipes in light of policy parameters provided by a network policy server.

### FIELD OF THE INVENTION

The present invention relates to communications, and in particular to a technique for controlling the allocation and use of bandwidth in a multi-service environment supported by a common access network.

### BACKGROUND OF THE INVENTION

Traditionally, dedicated access networks have been used to provide dedicated services. For example, cable networks would provide television services, telephone networks would provide telephone services, and data networks would provide data services. With the rapid acceptance and expansion of packet-based technologies, there is a movement toward providing disparate services over a common packet network.

While significant progress has been made to provide core networks capable of transporting packets for various services, access networks connecting to a subscriber's residence or place of business are still relatively separate. Although data services may be overlaid on telephony access networks, these access networks are not configured to support a wide range of simultaneous services such as telephony, video and multimedia. Further, there is little control over the various types of media provided via the data services.

As these media services mature, there will be a need to support voice, audio, video, and other real-time or streaming applications where timely delivery of packets is important over a common access network. Any access network providing a connection to the subscriber premises is likely to have limited bandwidth with respect to the number of services that are available and contending for that limited bandwidth. Given the movement to provide multiple services over a single access network and the different quality of service requirements associated with these services, there is a need for a technique to control the allocation of bandwidth for services and assure that subscribers are not allowed access to bandwidth or services to which they are not entitled. In essence, there is a need to provide control and policing on a service-by-service basis over a common access network.

### SUMMARY OF THE INVENTION

The present invention allows different types of services to be implemented over a common local access network, wherein each service can be ensured the resources necessary to provide the service, and unauthorized use can be prevented. Accordingly, various types of media services, including voice, audio, video, and data services, may be provided to various types of customer premise equipment, and the packet flows for each of these services may be individually controlled. On either side of the local access network, a customer service edge and a network service edge are provided to establish virtual communication pipes for the respective services. The customer and network service edges will establish the virtual communication pipes and control traffic flow over the virtual communication pipes in light of policy parameters provided by a network policy server. The network policy server will respond to requests for resources to implement a service by determining if the service can be provided to the customer and if there are sufficient resources available to fulfill the service in light of other services being provided. The network policy server will individually instruct accordingly the customer service edge, the network service edge and any other network equipment in the service path that require those policies. In operation, the customer service edge will control packet flows from the customer premise equipment and the network service edge will control packet flows to the customer premise equipment. As such, different types of services with different resource requirements, including quality of service levels, may be maintained over a common local access network in an efficient and effective manner.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a communication environment according to one embodiment of the present invention.

FIGS. 2A-2C represent an exemplary communication flow according to one embodiment of the present invention.

FIG. 3 is a block representation of a customer service edge according to one embodiment of the present invention.

FIG. 4 is a block representation of a network service edge according to one embodiment of the present invention.

FIG. 5 is a block representation of a network policy server according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

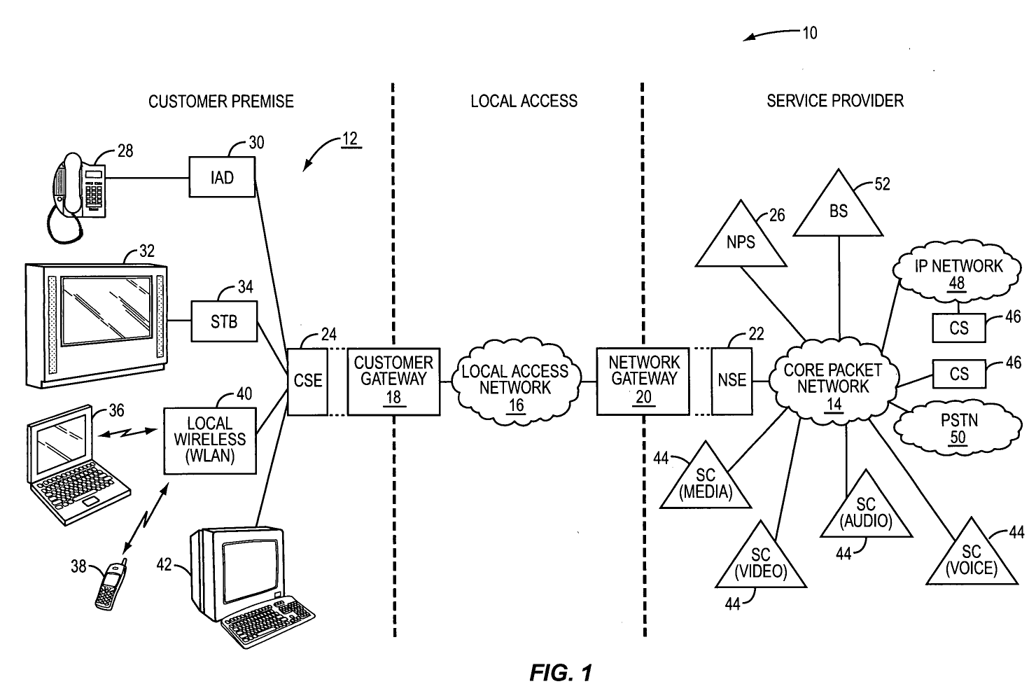

The present invention provides a unique way to allocate and control the partitioning of bandwidth for multiple services over a common access network, while ensuring quality of service and preventing unauthorized use. With reference to FIG. 1, a communication environment according to one embodiment of the present invention is illustrated. The communication environment 10 may include various types of customer premise equipment (CPE) 12 that receive packet-based services from a core packet network 14 via a local access network 16. Depending on the configuration, a customer gateway 18 may be provided to terminate the local access network 16 for the CPE 12. Similarly, a network gateway 20 may be provided to facilitate interworking between the local access network 16 and the core packet network 14. Additionally, a customer service edge (CSE) 24 is provided at the customer premise in a standalone device or integrated into the CPE 12 or customer gateway 18. Likewise, a network service edge (NSE) 22 is logically positioned between the local access network 16 or network gateway 20 and the core packet network 14. Like the CSE 24, the NSE 22 may be implemented in a standalone device or may be integrated into the network gateway 20 or other routing entity in the core packet network 14. For services provided to the CPE 12 via the local access network 16, the CSE 24 and the NSE 22 will operate to establish virtual communication pipes over the local access network 16 for each of the services provided to the CPE 12. In essence, the virtual communication pipes are virtual paths having defined parameters, which are sufficient to support the traffic flow, in either direction, associated with a particular service.

The CSE 24 and the NSE 22 operate under the control of a network policy server (NPS) 26, which essentially instructs the CSE 24 and the NSE 22 to establish the virtual communication pipes for selected services and control the traffic flows therein. The CSE 24 and NSE 22 will cooperate to allocate resources and ensure a desired quality of service, along with providing control or shaping of traffic flow for the service. Depending on the available bandwidth and the number of services implemented, the CSE 24 and NSE 22 may also provide packet queuing and make decisions on prioritizing packets based on the parameters associated with each service.

In one embodiment, different types of services may be supported over different virtual communication pipes to various ones of the CPE 12. The CPE 12 may take many forms and support various types of services, such as circuit-switched or packet-based telephony, television, data, audio, and video. Various types of CPE 12 are represented in FIG. 1, but those skilled in the art will recognize that the invention is not limited to the illustrated embodiments. Since the CPE 12 may take many forms, such as a telephony terminal 28, which is associated with the CSE 24 via an integrated access device (IAD) 30, which effectively performs voice over packet-to-Plain Old Telephone System (POTS) adaptation. For television service, a television 32 may be supported by a set top box (STB) 34, which cooperates with the CSE 24 to facilitate television service. A notebook computer or PDA 36, as well as a mobile terminal 38 may facilitate local wireless communications via a local wireless access point 40, which may facilitate local wireless communications using Wireless Local Area Network (WLAN), Bluetooth, or other local wireless technology. A personal computer 42 may also be logically associated with the CSE 24 to facilitate various types of media services, including streaming audio, video, and voice, along with traditional data services.

For any of the varied services capable of being provided to the CPE 12, the CSE 24 and the NSE 22 will function to allocate bandwidth for the virtual communication pipe and control the traffic flow for the service and other services and their respective virtual communication pipes to ensure that each service is delivered with an appropriate quality of service, as well as preventing unauthorized use of unallocated bandwidth.

In operation, the NPS 26 will have access to information bearing on the services that a particular subscriber is authorized to use. The information controlling access to these services is generally referred to as a user policy, which will have various parameters defining the resources that are either necessary or authorized to be used to facilitate the service. The NPS 26 will also keep track of the overall resources available through the local access network 16 as well as the services being implemented at any given time. As such, the NPS 26 will recognize which resources are being used and which resources are available for new services. Based on this information, intelligent decisions can be made to ensure that a requested service can be fulfilled.

In general, the services are provided in unidirectional or bi-directional communication flows with the CPE 12 over the local access network 16, wherein the packet flows are controlled in the downstream direction (toward the CPE 12) by the NSE 22, and controlled in the upstream direction (from the CPE 12) by the CSE 24. The traffic flows, which ride on top of the packet flows, are generally controlled by service controllers (SCs) 44, which may interact with the CPE 12 to facilitate the transmission of packets between the CPE 12 and a content server (CS) 46. In general, the service controllers 44 will cooperate with the content servers 46, and perhaps with the CPE 12, to facilitate the delivery of content to effect a service over one of the virtual communication pipes. Alternatively, the services may be provided by other entities provided in an associated Internet Protocol (IP) network 48 or the Public Switched Telephone Network (PSTN) 50, which may be coupled to the core packet network 14 via an appropriate gateway (not shown).

Thus, the NPS 26 will instruct the CSE 24 and NSE 22 to establish a virtual communication pipe for a requested service. Once the virtual communication pipe is established, the service controllers 44 will communicate with the appropriate content server 46, and perhaps the affected CPE 12, to facilitate packet delivery for the requested service. If the requested service is high-definition television content, the content server 46 delivers a high-definition television program over an appropriately configured virtual communication pipe to the television 32 via the set top box 34. The CSE 24 and NSE 22 ensure that the content is delivered with a required quality of service, and ensure that other services do not interfere with the high-definition television content. The NPS 26 controls the CSE 24 and NSE 22 to ensure that the services do not conflict. To prevent such conflict, a requested service may be denied if there is insufficient bandwidth or other resources to provide the service; quality of service levels may be adjusted, if authorized, to accommodate the multiple services; or a service may be eliminated according to a defined priority profile.

In one embodiment of the present invention, the various services may be accounted for in different manners, such that telephone services are billed at a different rate than television or data services. In this instance, various ones of the NSE 22, NPS 26, service controller 44, or content server 46 may facilitate accounting or billing, and may generate billing information or send sufficient information to a billing server (BS) 52 to effect billing for the particular services. Depending on the implementation of the services, each service may be accounted for on a per-service basis, such as pay-per-view television, or a service may be provided on a limited basis for a monthly fee wherein additional features may include additional charges.

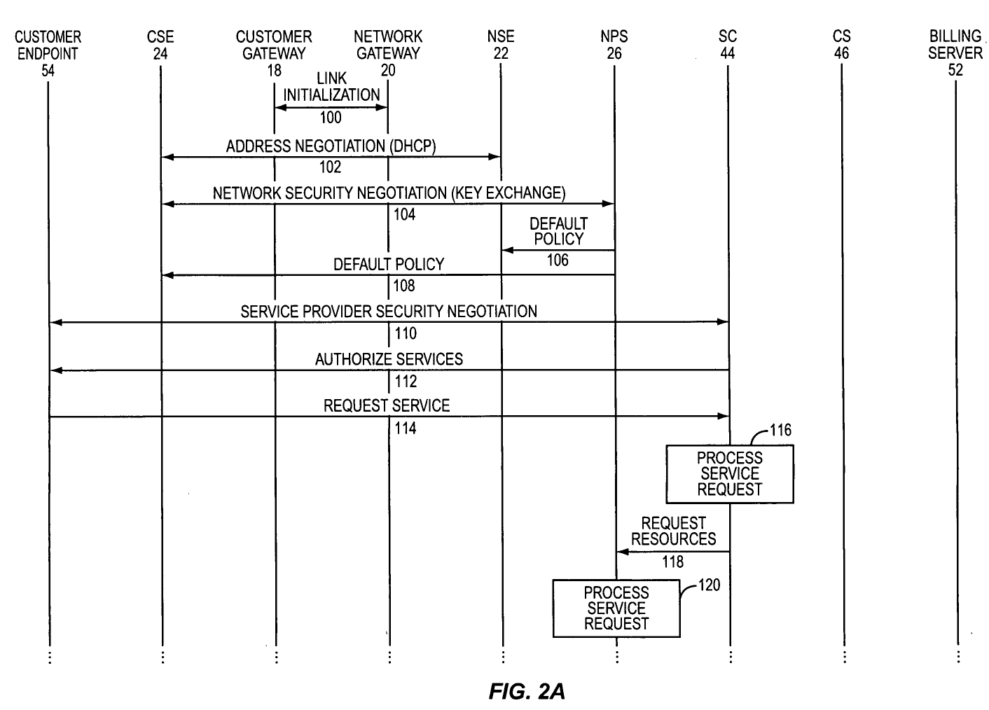

Turning now to FIGS. 2A-2C, an exemplary communication flow is provided for requesting and fulfilling a service according to one embodiment of the present invention. Initially, the physical communication link between the customer gateway 18 and the network gateway 20 must be initialized, such that communications across the local access network 16 may be facilitated (step 100). Next, the CSE 24, which preferably communicate using the Internet Protocol (IP), will determine its IP address and other basic connectivity provisioning data by using protocols such as Dynamic Host Configuration Protocol (DHCP), assuming this data is not pre-provisioned (step 102). The NSE 22 would typically relay the DHCP requests to a DHCP server connected on the core packet network. To establish a security policy, the CSE 24 and NPS 26 may negotiate a network security policy and exchange any public or private encryption keys to use for future communications (step 104). At this point, the NPS 26 recognizes that the CSE 24 is functional and ready to facilitate services for the CPE 12, and will send default policy parameters to both the NSE 22 and the CSE 24 (steps 106 and 108). These default parameters may establish any basic services that are always available to the CPE 12, as well as allow basic information exchange to request additional services. The NSE 22, being typically located on the telecom operators' premise, is a trusted network entity and does not need to go through the same authentication and authorization process.

For purposes of illustration, assume that a particular CPE 12 is generally referenced as a customer endpoint 54. The customer endpoint 54 will request a service, which will require the establishment of a virtual communication pipe and a certain quality of service level. Initially, the customer endpoint 54 may communicate with a selected service controller 44 associated with a service provider to establish a secured and authenticated relationship allowing the service controller 44 to trust service requests coming from the customer endpoint 54 (step 110). At some point, the service controller 44 will send a final authorization to the customer endpoint 54, allowing it to request services (step 112). When a user desires a particular service, the customer endpoint 54 will generate and send a request for the service to the service controller 44 (step 114), which will process the service request (step 116) to determine if the customer endpoint 54 is authorized to receive the service. If the customer endpoint is authorized to receive the service, the service controller 44 will request resources for the service by sending an appropriate message to the NPS 26 (step 118). The NPS 26 will process the resource request to determine if the resources for the service are available (step 120). The NPS 26 maintains a network topology database which keeps track of what resources (such as bandwidth, multiplexing points, etc.) are available at various points in the access network. The NPS 26 also keeps track of the existing traffic flows running in the access network and how much of the access network resources are currently used up by the existing traffic flows. If the network resources allow the newly requested traffic flow to be set up, the NPS 26 will add the new traffic flow to its database. In addition to determining if the resources are available for the service, the NPS 26 may also determine whether the resources should be allocated for the service based on a service policy associated with the user or the particular customer endpoint 54.

Assuming the resources are available and the network policy dictates that the resources can be allocated for the service, the NPS 26 will create a service policy, which defines the parameters that will be used to control the packet flow over the local access network 16 for the service. The service policy is then sent to the NSE 22 (step 122), which will implement the service policy for downstream packet flows (step 124), and acknowledge receipt of the service policy (step 126). Similarly, the NPS 26 will send a service policy to the CSE 24 (step 128), which will implement the service policy for upstream traffic flows (step 130) and acknowledge receipt of the service policy (step 132). The parameters received in association with the service policy at the CSE 24 and the NSE 22 are sufficient to establish the virtual communication pipe for the service and control packet flow for the services according to the various parameters, which may control quality of service levels, queuing, traffic control or shaping, or any necessary filtering, in either direction. In the illustrated embodiment, the CSE 24 uses the service policy parameters to control upstream traffic from the customer endpoint 54 to the content server 46 and the NSE 22 will use the service policy parameters to control the traffic flow from the content server 46 to the customer endpoint 54.

Once the service policies are in place at the CSE 24 and the NSE 22, the NPS 26 will instruct the service controller 44 to enable the service (step 134). In response, the service controller 44 will instruct the content server 46 to initiate the service (step 136), and may send a message to the customer endpoint 54 to initiate the service or indicate that the service has been initiated (step 138). At this point, the service is initiated, and the packet flow for the requested service may take place between the customer endpoint 54 and the content server 46 over the virtual communication pipe (step 140). Notably, the content server 46 is only used for illustration, and those skilled in the art will recognize that the content server 46 may represent a telephony device, streaming audio or video service, television service, data service, video conferencing service, or virtually any other media service requiring a certain level of quality of service and for which differentiated accounting may be desired.

Throughout the service being provided, the CSE 24 and the NSE 22 will continue managing the respective packet flows according to the policy parameters (step 142 and 144). Such management will include classifying traffic flows for the various services that are implemented; providing queuing; maintaining a desired quality of service; shaping, controlling, or filtering the traffic; or preventing unauthorized use of the local access network 16 by other CPEs 12. The CSE 24 and NSE 22 will effectively route all traffic for all services over the appropriate virtual communication pipes according to the defined policy parameters. Traffic for the service may be recognized by checking an identifier or label provided with the packets and associated with the particular service. In a preferred embodiment, the source and destination addresses, and potentially the respective ports used by the CPE 12 and the content server 46, are monitored to identify packets to be transported over the virtual communication pipe in association with the service and according to the policy parameters. Accordingly, differentiated services may be provided over a single local access network 16 in a controlled fashion. With the present invention, the local access network 16 can be effectively partitioned among multiple services in a manner wherein the respective services will not negatively impact the others.

In addition to the above benefits, another embodiment of the present invention allows for differentiated billing for the respective services. Since the services may be established on an individual basis, accounting for these services may also be provided on an individual basis. Various entities illustrated in FIG. 1 may be used to collect accounting information, which will be processed and sent directly or indirectly to the billing server 52. The accounting information may be processed during the service, after the service, or a combination thereof. For example, when a service is terminated, the customer endpoint 54 may send a request to terminate the service to the service controller 44 (step 146), which will send a message to the content server 46 to terminate the service (step 148), as well as sending a message to terminate the service to the customer endpoint 54 (step 150). The service controller 44 will notify the NPS 26 that the service is terminated (step 152). In response, the NPS 26 will take the necessary steps to remove the service policy and tear down the virtual communication pipe established between the CSE 24 and the NSE 22.

The NPS 26 may send a message to terminate the service policy to the NSE 22 (step 154), which may send an acknowledgement back to the NPS 26 (step 156). The NPS 26 will then send a message to terminate the service policy to the CSE 24 (step 158), which may respond with an acknowledgement to the NPS 26 (step 160). If billing is based on content, the service controller 44 may generate billing information (step 162) and send the billing information to the billing server 52 (step 164). Alternatively, the NSE 22 may generate the billing information (step 166) and forward the billing information to the service controller 44 or directly to the billing server 52 (step 168). Those skilled in the art will recognize numerous techniques for monitoring the service, accounting for the service, and delivering accounting or billing information to an appropriate billing server 52 to facilitate billing for the provided service.

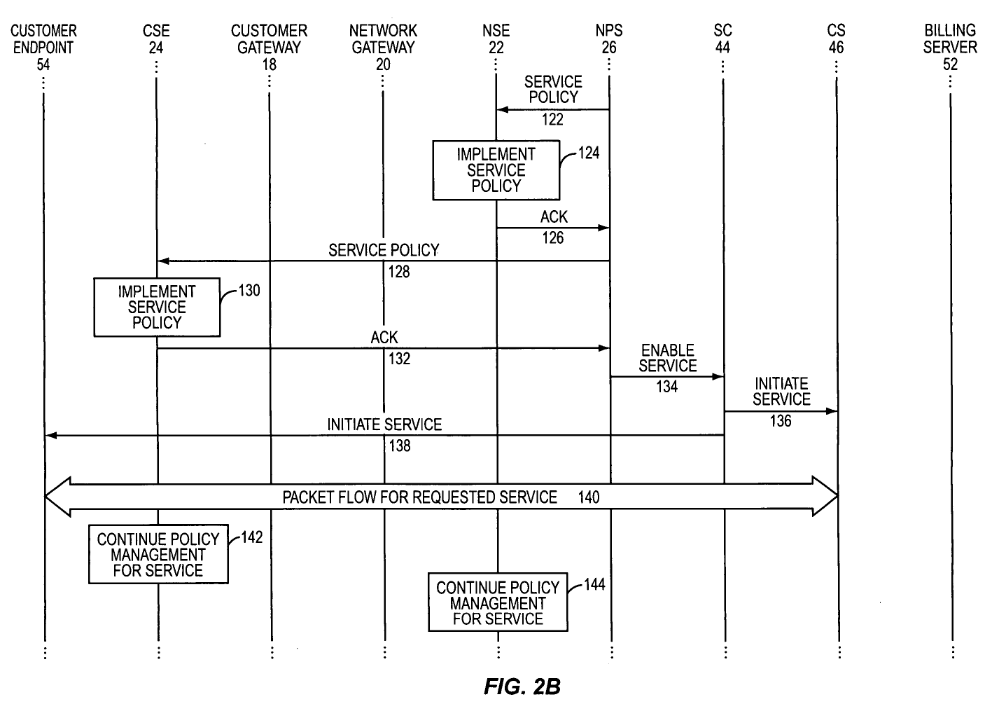

Turning now to FIG. 3, a block representation of a CSE 24 is provided according to a standalone embodiment of the present invention. The CSE 24 may include a control system 56 having memory 58 with sufficient software 60 to facilitate operation as described above. In particular, a policy enforcement function 62 is implemented in the software 60 to communicate with the NPS 26 and the NSE 22 to establish virtual communication pipes and enforce policies for the service according to the parameters received from the NPS 26. The control system 56 may be associated with one or more communication interfaces 64 to facilitate communication with the customer gateway 18 or local access network 16, as well as with various ones of the CPE 12.

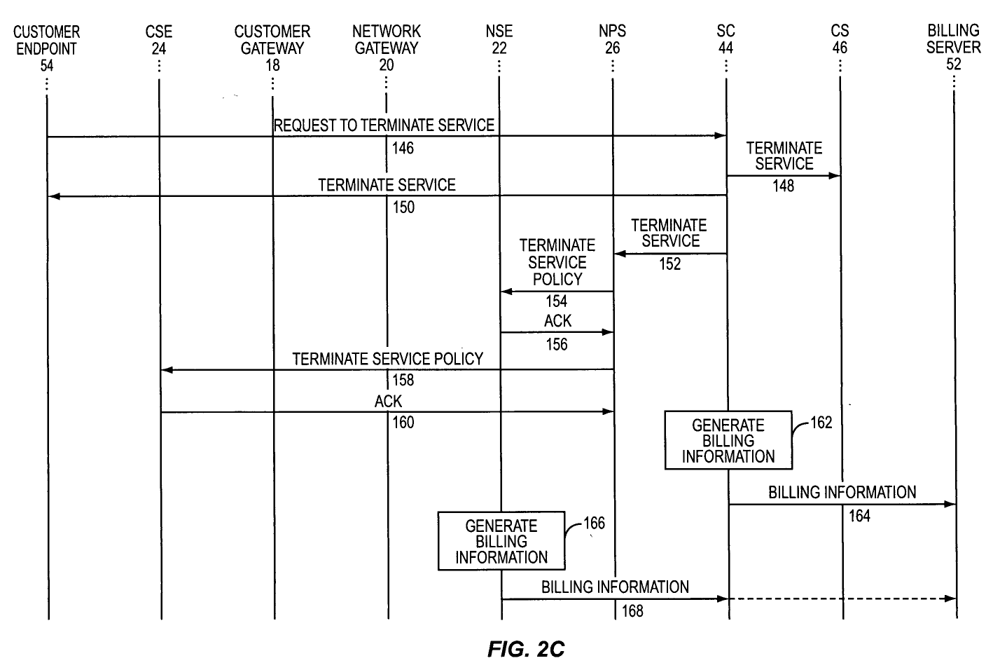

As seen in FIG. 4, the NSE 22 is configured similarly to the CSE 24. The NSE 22 will include a control system 66 having memory 68 with sufficient software 70 to operate as described above. The software 70 will provide a policy enforcement function 72 to establish virtual communication pipes with the CSE 24 over the local access network 16 and control services according to parameters received from the NPS 26. The control system 66 will be associated with one or more communication interfaces 74 to facilitate communication over the local access network 16 directly or indirectly via the network gateway 20, as well as with the NPS 26.

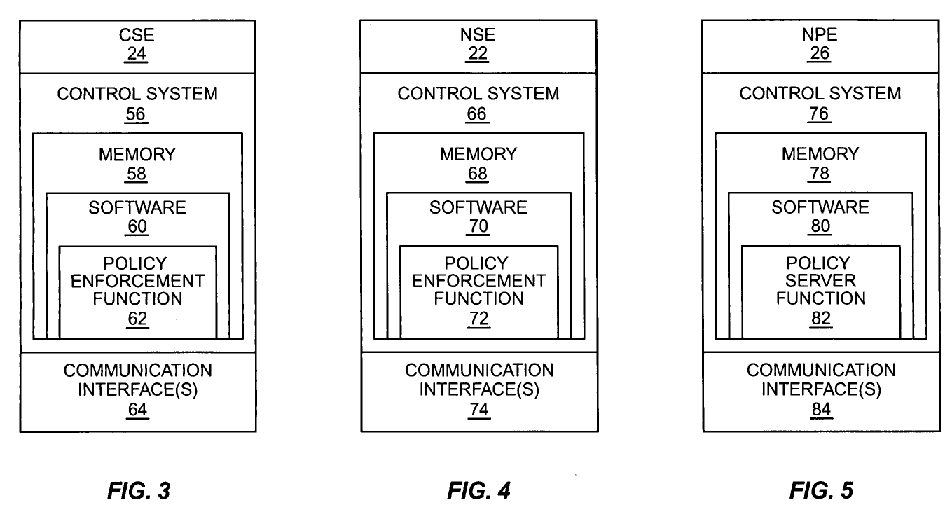

With reference to FIG. 5, the NPS 26 represents a logical function, but may be implemented in a traditional network server having a control system 76 with memory 78 for software 80 to control the operation as described above. The software 80 will include a policy server function 82, which will act to control the CSE 24 and the NSE 22 to provide and control services over the local access network 16, as well as cooperate with the content servers 44 or other entity involved in providing the service. For such communications, the control system 76 is associated with at least one communication interface 84.

Those skilled in the art will recognize improvements and modifications to the preferred embodiments of the present invention. All such improvements and modifications are considered within the scope of the concepts disclosed herein and the claims that follow.

1. A method for providing disparate services to customer premise equipment over a local access network wherein a customer service edge is provided between the local access network and the customer premise equipment and a network service edge is provided between the local access network and a core network, the method comprising:
a) receiving a request for resources in association with a request for a service involving the customer premise equipment;
b) generating policy parameters sufficient to establish a virtual communication pipe between the customer service edge and the network service edge over the local access network and to control packet flow over the virtual communication pipe to facilitate the service; and
c) sending at least certain of the policy parameters to the customer service edge and the network service edge to establish the virtual communication pipe and to control the packet flow for the service in response to the request for resources.

2. The method of claim 1 wherein the request for resources is received from a service controller, which is capable of initiating the service.

3. The method of claim 1 wherein a plurality of services are provided via a plurality of virtual communication pipes over the local access networks.

4. The method of claim 3 wherein the plurality of services are different types of services.

5. The method of claim 4 wherein the different types of services are associated with different parameters, which define different sets of resources and control necessary for providing the different types of services.

6. The method of claim 5 further comprising effecting accounting for each of the plurality of services and providing accounting information for each of the plurality of services to a billing entity.

7. The method of claim 1 further comprising determining if the local access network has sufficient resources available to establish the virtual communication pipe and support the service.

8. The method of claim 1 further comprising determining if the virtual communication pipe can be established for the service based on a network access policy associated with a user of the customer premise equipment.

9. The method of claim 1 wherein the policy parameters provided to the customer service edge define a quality of service level for packets sent from the customer service edge and the policy parameters provided to the network service edge define quality of service levels for packets sent from the network service edge.

10. The method of claim 1 wherein the policy parameters provided to the customer service edge define control or shaping parameters for packets sent from the customer service edge and the policy parameters provided to the network service edge define control or shaping parameters for packets sent from the network service edge.

11. The method of claim 1 wherein the policy parameters provided to the customer service edge define queuing parameters for packets sent from the customer service edge and the policy parameters provided to the network service edge define queuing parameters for packets sent from the network service edge.

12. The method of claim 1 wherein packets for the service are identified using at least one of the group consisting of source address, destination address, source port, and destination port.

13. The method of claim 1 further comprising effecting accounting for the service and providing accounting information for the service to a billing entity.

14. The method of claim 1 further comprising sending messages to the customer service edge and the network service edge to terminate the virtual communication pipe and stop delivery of packets for the service over the local access network.

15. A method for providing disparate services to customer premise equipment over a local access network comprising:
a) providing a customer service edge and a network service edge at either end of a local access network to control services delivered to customer premise equipment over the local access network;
b) receiving from policy parameters at the customer service edge and the network service edge, the network policy parameters sufficient to establish a virtual communication pipe between the customer service edge and the network service edge over the local access network and to control packet flow over the virtual communication pipe to facilitate the service;
c) establishing the virtual communication pipe between the customer service edge and the network service edge;
d) controlling packet flow from the customer premise equipment with the customer service edge based on at least certain of the policy parameters; and
e) controlling packet flow to the customer premise equipment with the network service edge based on at least certain of the policy parameters.

16. The method of claim 15 wherein the local access network is operatively coupled to a core packet network over which the service is provided.

17. The method of claim 15 wherein a plurality of services are provided via a plurality of virtual communication pipes over the local access networks.

18. The method of claim 17 wherein the plurality of services are different types of services.

19. The method of claim 18 wherein the different types of services are associated with different parameters, which define different sets of resources and control necessary for providing the different types of services.

20. The method of claim 15 wherein the policy parameters provided to the customer service edge define a quality of service level for packets sent from the customer service edge and the policy parameters provided to the network service edge define quality of service levels for packets sent from the network service edge.

21. The method of claim 15 wherein the policy parameters provided to the customer service edge define control or shaping parameters for packets sent from the customer service edge and the policy parameters provided to the network service edge define control or shaping parameters for packets sent from the network service edge.

22. The method of claim 15 wherein the policy parameters provided to the customer service edge define a queuing parameters for packets sent from the customer service edge and the policy parameters provided to the network service edge define queuing parameters for packets sent from the network service edge.

23. The method of claim 15 wherein packets for the service are identified by the customer service edge and the network service edge using at least one of the group consisting of source address, destination address, source port, and destination port.

24. A system for providing disparate services to customer premise equipment over a local access network wherein a customer service edge is provided between the local access network and the customer premise equipment and a network service edge is provided between the local access network and a core network, the system comprising:
a) at least one communication interface; and
b) a control system associated with the at least one communication interface and adapted to:
i) receive a request for resources in association with a request for a service involving the customer premise equipment;
ii) generate policy parameters sufficient to establish a virtual communication pipe between the customer service edge and the network service edge over the local access network and to control packet flow over the virtual communication pipe to facilitate the service; and
iii) send at least certain of the policy parameters to the customer service edge and the network service edge to establish the virtual communication pipe and to control the packet flow for the service in response to the request for resources.

25. The system of claim 24 wherein the request for resources is received from a service controller, which is capable of initiating the service.

26. The system of claim 24 wherein a plurality of services are provided via a plurality of virtual communication pipes over the local access networks.

27. The system of claim 26 wherein the plurality of services are different types of services.

28. The system of claim 27 wherein the different types of services are associated with different parameters, which define different sets of resources and control necessary for providing the different types of services.

29. The system of claim 24 wherein the control system is further adapted to determine if the local access network has sufficient resources available to establish the virtual communication pipe and support the service.

30. The system of claim 24 wherein the control system is further adapted to determine if the virtual communication pipe can be established for the service based on a network access policy associated with a user of the customer premise equipment.

31. The system of claim 24 wherein the policy parameters provided to the customer service edge define a quality of service level for packets sent from the customer service edge and the policy parameters provided to the network service edge define quality of service levels for packets sent from the network service edge.

32. The system of claim 24 wherein the policy parameters provided to the customer service edge define control or shaping parameters for packets sent from the customer service edge and the policy parameters provided to the network service edge define control or shaping parameters for packets sent from the network service edge.

33. The system of claim 24 wherein the policy parameters provided to the customer service edge define a queuing parameters for packets sent from the customer service edge and the policy parameters provided to the network service edge define queuing parameters for packets sent from the network service edge.

34. The system of claim 24 wherein packets for the service are identified using at least one of the group consisting of source address, destination address, source port, and destination port.

35. The system of claim 24 wherein the control system is further adapted to effect accounting for the service and provide accounting information for the service to a billing entity.

36. The system of claim 24 wherein the control system is further adapted to send messages to the customer service edge and the network service edge to terminate the virtual communication pipe and stop delivery of packets for the service over the local access network.

37. A system for providing disparate services to customer premise equipment over a local access network comprising:
a) means for providing a customer service edge and a network service edge at either end of a local access network to control services delivered to customer premise equipment over the local access network;
b) means for receiving from policy parameters at the customer service edge and the network service edge, the policy parameters sufficient to establish a virtual communication pipe between the customer service edge and the network service edge over the local access network and to control packet flow over the virtual communication pipe to facilitate the service;
c) means for establishing the virtual communication pipe between the customer service edge and the network service edge;
d) means for controlling packet flow from the customer premise equipment with the customer service edge based on at least certain of the policy parameters; and
e) means for controlling packet flow to the customer premise equipment with the network service edge based on at least certain of the policy parameters.

38. The system of claim 37 wherein the local access network is operatively coupled to a core packet network over which the service is provided.

39. The system of claim 37 wherein a plurality of services are provided via a plurality of virtual communication pipes over the local access networks.

40. The system of claim 39 wherein the plurality of services are different types of services.

41. The system of claim 40 wherein the different types of services are associated with different parameters, which define different sets of resources and control necessary for providing the different types of services.

42. The system of claim 37 wherein the policy parameters provided to the customer service edge define a quality of service level for packets sent from the customer service edge and the policy parameters provided to the network service edge define quality of service levels for packets sent from the network service edge.

43. The system of claim 37 wherein the policy parameters provided to the customer service edge define control or shaping parameters for packets sent from the customer service edge and the policy parameters provided to the network service edge define control or shaping parameters for packets sent from the network service edge.

44. The system of claim 37 wherein the policy parameters provided to the customer service edge define a queuing parameters for packets sent from the customer service edge and the policy parameters provided to the network service edge define queuing parameters for packets sent from the network service edge.

45. The system of claim 37 wherein packets for the service are identified by the customer service edge and the network service edge using at least one of the group consisting of source address, destination address, source port, and destination port.
